(19) United States
(12) Patent Application Publication
(10) Pub. No.: US 2008/0169140 A1
(43) Pub. Date: Jul. 17, 2008

(54) Machine for augmentation, storage, and conservation of vehicle motive energy

(76) Inventor: Charles Hampton Perry, Murfreesboro, TN (US)

Correspondence Address: David D. Winters, Suite 237, 2277-C Wilma Rudolph Blvd., Clarksville, TN, 37040-5898, US

(21) Appl. No.: 12/008,415

(22) Filed: Jan. 11, 2008

Related U.S. Application Data
(60) Provisional application No. 60/880,373, filed on Jan. 16, 2007.

(51) Int. Cl. B60W 20/00; H02K 11/00; B60K 6/26; B60L 11/12

(52) U.S. Cl. 180/65.2; 310/68 B; 290/9; 180/65.3; 903/906

(57) ABSTRACT

A machine for addition of motive force to a vehicle, with rotor plate, rotor arms, rotor permanent magnets, stator plate, stator columns, stator electro magnets, and battery, cell, or other energy storage device.

### CROSS REFERENCE TO RELATED APPLICATIONS

This application is based on provisional application SER. No. 60/880,373 filed on Jan. 11, 2007.

### STATEMENT REGARDING FEDERALLY SPONSORED RESEARCH OR DEVELOPMENT

Not Applicable

### DESCRIPTION OF ATTACHED APPENDIX

Not Applicable

### PREAMBLE AND OVERVIEW

There are previous technologies that propose means to convert the present fleet of gasoline powered vehicles to hybrid electrical units by means of a retrofit kit. The solution typically consists of placing one or more electric motors at or on the wheels of a given vehicle and then tying those motors to a battery and a controller similar to the one used in new design-built hybrid vehicles. This solution has had significant cost obstacles. The greatest challenge has been to design an affordable and efficient method for installing the electric motor drive.

The typical solution has involved the replacement or substantial modification of the existing wheel structure, including the wheel, bearings and brakes. Because of this replacement, other engineering issues arise, such as the location, design and coordination of the electric motors as well as the addition of un-sprung weight to the suspension system. Most important, the expense of the replacement of the existing wheel structure and related systems becomes prohibitive when the entire wheel structure is being replaced. This invention specifically addresses that challenge.

This invention discloses a new design for a wheel hub motor to provide motive power to automotive vehicles. In the preferred embodiment, the wheel hub motor is integral with the structure of the axle/hub/spindle/brake assembly on the wheel of an automobile.

Previous technologies have utilized a wheel hub electric motor that also incorporated other wheel functions such as bearings, axle, and brakes, requiring significant modification and re-design to do so. The herein taught art utilizes the existing axle, bearings, brake structure and adds the wheel hub motor capability essentially without modifying the existing wheel structure.

The advantages of this approach include: lower cost, simplicity of performing the retrofit, and simplicity of performing maintenance on both the electric motor and the existing brake, bearings and wheel structure. The addition of retrofit associated, easily integrated hybrid components such as battery pack, control electronics, electric motor, and wiring would allow “plug-and-go” in hybrid operation to any automobile.

In the preferred embodiment, the rotor and stator can be constructed of corrosion resistant materials so that exposure to normal operating conditions does not degrade performance. The reliability of the vehicle bearings and brakes is unaffected by the addition of the stator and rotor of the wheel hub motor. The described wheel hub motor system is also compatible with maintenance requirements. When conventional maintenance to the rear brake assembly is required, the tire/wheel is removed in the normal manner and the rotor is also removed from the lug bolts. Since the stator plate is located behind the brake spindle assembly, it does not affect the repair procedure.

This invention addresses the challenge of adding electric motor operation to an existing vehicle without extensive mechanical modification or impacting performance, reliability and maintenance. The rotor and stator assemblies are mechanically simple components and could be produced at low costs for high volume production. Cost is also lowered because the load bearing and braking function of the wheel as designed by the automotive designer is not changed. Therefore, the expense of designing and testing this important mechanical system is not necessary. Because the wheel hub motor is a retrofit of the existing structure, modification of existing systems and repair procedures are also simplified.

FIGS. 14 and 15 generally illustrate the rear wheel components as fitted to the wheel of any automobile or small truck. If the vehicle has a front-wheel drive system, the rear wheel/tire is mounted on a spindle assembly comprised of a non-rotating axle, bearings, brakes, rotating hub/drum, and associated mounting bolts. If the vehicle has a rear-wheel drive system, a rotating driving axle extends from the differential to each rear wheel. In FIGS. 14 and 15, the spindle assembly is shown with drum brakes, although the same principle applies if there are disk brakes. With either type of braking system, there is a cylindrical volume taken up by the rotating hub/disk assembly. The spindle assembly consisting of the bearings, rotating hub, and brakes is mounted to a backing plate with four bolts as shown. This rear spindle mounting method is used in both front and rear wheel drive automobiles. The wheel/tire is attached to the spindle assembly using the lug bolts extending from the spindle assembly.

FIG. 9 shows the tire/wheel, brake assembly, and backing plate along with two additional components, the rotor plate and stator plate. The rotor and stator together form a DC brushless motor, which is integral with the existing rear wheel/spindle. The stator plate is mounted between the brake assembly and backing plate, and is held in place by the four mounting bolts/nuts. The stator assembly mounting plate does not affect the mechanical integrity of the suspension components, but the rear wheel track width is widened slightly on both the left and right rear wheels of the vehicle. The rotor plate mounts on the lug bolts of the brake assembly as shown and the tire/wheel assembly is placed on the brake assembly and the lug nuts tightened in the usual manner. The thickness of the rotor plate increases the total rear wheel track width slightly due to the addition of both stator and rotor plates on both rear wheels.

The C-magnets shown in FIG. 9 are preferably ironless electromagnets which are activated by an electronic motor control. (The windings and the standard connecting wiring on the stator C-magnets are omitted for clarity.) The permanent magnets on the rotor plate are also shown in FIG. 9. The interactions of the permanent magnets on the rotor with the energized electromagnets on the stator form the basic components of a brushless DC electric motor that provides torque to the rear wheels.

FIGS. 12 and 13 shows another view of the individual components and also a view with all four components assembled which forms a clamshell DC brushless motor surrounding the brake assembly. When assembled the stator and rotor are an integral part of the rear wheel assembly and make use of the existing axle, bearings, and brakes. By integrating a stator and rotor into an existing rear spindle assembly, the added mechanical design, cost, and reliability issues of axle, bearings, and brakes inherent in other wheel hub motor applications are avoided.

FIG. 11 shows the rear wheel attached to the brake assembly as in normal vehicle operation. The rotor and stator are integrated into the rear wheel components in such a way as to be mechanically transparent when the DC brushless motor is not in operation with the exception of added un-sprung mass.

The C-magnets can contain non-ferromagnetic or ferromagnetic materials. If the C-magnets are non-ferromagnetic there is-minimum interaction between the permanent magnets and the C-magnets when the motor is not in operation. This separation between magnets minimizes unnecessary load on the primary internal combustion engine when the hybrid system is not in use, for instance when the hybrid batteries have reached a low charge state or the system is turned off.

Also, the rotor and stator can be constructed of corrosion resistant materials so that exposure to normal operating conditions does not degrade performance. The reliability of the vehicle bearings arid brakes is unaffected by the addition of the stator and rotor of the wheel hub motor. The described wheel hub motor system is also compatible with maintenance requirements. When conventional maintenance to the rear brake assembly is required. The tire/wheel is removed in the normal manner and the rotor is also removed from the lug bolts. Since the stator plate is located behind the brake spindle assembly, it does not affect or inhibit the repair procedure.

### BACKGROUND OF THE INVENTION

This invention relates generally to the field of hybrid internal combustion-electric powered vehicles and more specifically to machine for augmentation, storage, and conservation of vehicle motive energy.

In the instant specification and claims, the process of installing or including electrical energy augmentation of an internal combustion powered vehicle is referred to as “hybridization”. Vehicles thusly augmented will be referred to as “hybridized.” Further, in the instant specification and claims, the terms “modify,” “sophistication,” and forms thereof exclude such simple and inexpensive processes as drilling holes in extant elements merely to provide anchor points to interface components or to bracket or attach elements to extant components. The term “conventional” is used to indicate an internal combustion engine or vehicle.

It has long been known that internal combustion engines used to propel vehicles operate most efficiently at a particular level or speed. However, in normal driving, the vehicle is called upon to climb and descend hills, stop and start, accelerate and brake, or cruise at high speeds on highways, all of which combine to put a wide range of demands on the power plant requiring it to operate over a wide range of power and operate over a wide range of speeds.

Thus, the internal combustion engine powering the vehicle will not usually be operating at its most efficient level. In fact, in the severe stop-and-go situations in which most driving is accomplished, the efficiency will generally be quite low. Therefore, alternate drive systems and power sources to increase efficiency have been devised.

One such effective system, popularly known as “hybrid,” involves combining a battery powered electric motor with an internal combustion engine in such a manner that the internal combustion engine may operate at a relatively constant level as close as possible to that of its maximum efficiency.

This is accomplished by exploiting the electric motor to augment the internal combustion engine to prevent it from having to operate above its preferred power level. In example, when the vehicle must accelerate from a stop to particular speed, the electric motor is engaged to such degree that the internal combustion engine need not exceed its optimal power output. Also, when increased speed is desired, the internal combustion engine may run at its preferred power level while the electric motor adds the required extra power.

The hybrid may also comprise means to convert the electric motor to an electric power source when the vehicle is braking or traveling downhill. Employed thus, momentum of the vehicle may be used to recharge the battery, cell, or other energy storage device, thereby literally recycling and exploiting for propulsion, energy that would otherwise be lost.

The hybrid may also have a means to recharge the battery, cell, or other energy storage device by plugging it into an electric power grid. Since most people sleep at night, most recharging could be done during non-peak power demand hours thusly using cheaper, low demand electricity.

In addition, many other benefits, both economic and ecological, well known to those well versed in the art, may accrue due to hybridization of motor vehicles. However, up until now, the high cost to end users of implementing this art has prevented wide scale adoption.

Typically, a hybrid vehicle is designed and manufactured, ab initio, as a new vehicle because its manufacture requires inclusion of additional elements. Because the traditional elements present in exclusively internal combustion vehicles must be redesigned to accommodate the additional hybridizing elements and therefore, specially manufactured, economy of scale may not be achieved.

Further, even if a new hybrid vehicle could be brought to end users at a competitive price, market penetration would still be very slow due to the hundreds of millions of conventional vehicles already on the road world-wide, the abandonment of which could not be effected without serious economic disadvantage to the owners.

There is a variety of previously disclosed arts that propose means to convert the present conventional vehicles on the road to hybrid status. However, none have proved economically advantageous to a consumer, due primarily to the same obstacles facing new hybrid vehicles. The obstacle is that essentially all designs require extensive modification of existing automobile parts and/or the replacement of significant elements. In example wheel hub structures, require newly, and expensively, redesigned and manufactured substitutes. This example is particularly important to note in the light of the invention disclosed herein.

The instant invention provides means to produce a new hybrid vehicle essentially without replacement or significant modification of any presently designed and/or manufactured vehicle element, and also by provides means to convert an existing conventional vehicle to a hybrid essentially without significantly modifying or replacing any existing element. In this, it is a needed and highly desirable advancement in the art of hybridizing internal combustion vehicles.

U.S. Pat. Nos. 4,165,795 by Lynch et al. and 4,335,429 by Kawakatsu disclose hybrid drive systems for automobiles wherein an internal combustion engine is augmented by a battery powered electric motor. Also, both patents teach electric motors and internal combustion engines communicating with common drive shafts. In addition, the electric motors taught by Lynch et al. and Kawakatsu comprise housings, shafts, armatures, and bearings intrinsic to said motors.

In contrast to Lynch et al. and Kawakatsu, the instant art teaches an electric motor to be fitted on and within an internal combustion powered automobile, which exploits non-modified elements normally present in an internal combustion powered vehicle, using these elements to mount or serve as armature, shaft, housing, and bearings, but which is not in communication with the drive shaft served by the internal combustion engine.

In further contrast, the instant art teaches a stator and a rotor being held in operative magnetic communication with each other by connective devices which also hold in operable position un-modified conventional components of an internal combustion vehicle. Thus, the stator and rotor may be added or removed essentially without displacing or otherwise effecting the vehicle's conventional drive system.

U.S. Pat. No. 4,714,854 by Oudet and the monograph, Optimal Design and Control of Axial-Flux Brushless DC Wheel Motor For Electric Vehicles, by Y. P. Yang et al. teach electric motors suitable for use in a hybrid electric and internal combustion, power system for a vehicle. Said motors comprise armatures, shafts, housings, and bearings intrinsic to such motors. Thus, these motors may function independently of any elements comprised by an associated vehicle.

In contrast to Oudet and Yang et al., the instant art exploits non-modified elements normally present in an internal combustion engine powered vehicle to mount, contain, or serve as portions of armature(s), shaft(s), housing(s), and bearings. In further contrast, the instant art teaches a stator and a rotor being held in operative magnetic communication by connective devices which also hold in operable communication un-modified elements normally included in or comprising a conventional vehicle.

Because the instant art incorporates components of an associated vehicle, it may not function independently of an associated vehicle. However, the instant art may essentially be integrated into or removed from a vehicle without requiring replacement parts for, or effecting or disabling the vehicle on which it is or was installed. Simply by disengaging the connective devices and mounts, the elements may be disassociated from the vehicle and the rotor and/or stator may be disassociated from each other.

U.S. Pat. Nos. 5,438,228 by Couture et al.; 5,600,191 by Yang; 6,768,932 B2 by Claypole et al.; 2,514,460 by Tucker; and 5,157,295 by Stefansky et al. disclose in-hub wheel motors for rotating the wheels of a vehicle comprising specially designed hub elements contrived to support said in-hub wheel motors and to transfer force from said motors to said wheels.

In contrast to Couture et al., Yang, Claypole et al., Tucker, and Stefansky, the instant art requires no specially designed or modified vehicle elements in order to communicate force from a motor to a wheel but may communicate with the un-modified wheel and wheel support elements that would normally present in a conventional vehicle.

### BRIEF SUMMARY OF THE INVENTION

The primary object of the invention is provide low cost addition of electric power augmentation to an internal combustion engine vehicle without requiring modification of existing vehicle components.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for addition of motive force to a vehicle comprising: rotor plate, rotor arms, rotor permanent magnets, stator plate, stator arms, stator, and electro magnets.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic of a typical electric drive system.

FIG. 2 is a exploded view of elements of the instant art.

FIG. 3 is a side view of elements of the instant art with some in cross section.

FIG. 4 is a top view of an element of the instant art.

FIG. 5 is a side view of an element of the instant art.

FIG. 6 is a bottom view of an element of the instant art.

FIG. 7 is a side view of an element of the instant art.

FIG. 8 is a view of alternate dispositions of elements of the instant art.

FIG. 9 is a view of an alternate embodiment of an element of the instant art.

FIG. 10 is an exploded view of an embodiment of the instant art

FIG. 11 is a cross-sectional view of an embodiment of the instant art FIG. 12 is a ¾ exploded view FIG. 13 is a side assembled view FIG. 14 is a side exploded view of the manner of mounting the device, with tire FIG. 15 is a ¾ exploded view of the manner of mounting the device, with tire

### LIST OF COMPONENTS

10 Electric drive system
15 Electric motor
17 Motor sensor
19 Logic/control module
21 Battery, cell, or other energy storage device
23 Interface of engine load level sensor and logic/control module
25 Interface of logic/control module and battery, cell, or other energy storage device
27 Interface of battery, cell, or other energy storage device, and electric motor
28 Interface of electric motor and logic/control module
29 Engine level sensor
31 Non-movable axle support
33 Axle
35 Rigid hub portion
37 Rotating hub portion
39 Lug bolts
41 Rotor plate
43 Rotor plate holes
44 Rotor arm
45 Rotor permanent magnet
47 Hub bolt
49 Non-movable hub plate
51 Electromagnet
53 Slot
55 Stator plate
57 Stator plate hole
59 Stator arm
61 Stator ring
63 Hub mounted wheel motor
65 Wheel support hub
67 Rotor
69 Stator
75 Stator plate central void
77 Stator ring aperture
79 Backing plate
81 Tire
83 Wheel rim and hub
90 Electric motor
92 Wheel rim and hub hole

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

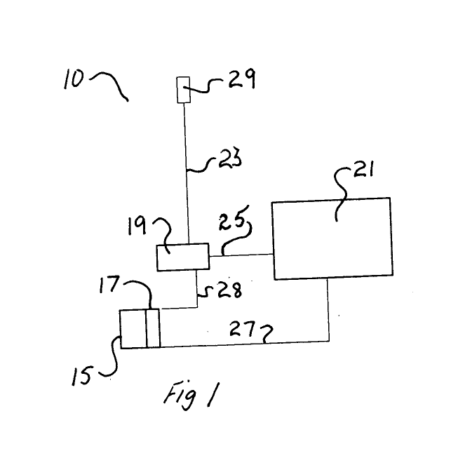

Looking now at FIG. 1, we see an electric powered drive system (10) for augmenting the internal combustion drive system of a vehicle, said electric drive system (10) comprising an electric motor (15) to communicate power to a vehicle wheel (not shown), having a sensor module (17) to detect electric motor (15) performance and electric motor (15) element disposition, a logic/control module (19), a battery (21), engine load level sensor (29), engine load level sensor- logic/control module interface (23), logic/control module-battery, cell, or other energy storage device interface (25), battery, cell, or other energy storage device-electric motor interface (27), and electric motor-logic/control module interface (28).

Those well versed in the art will readily recognize that such electric powered drive systems as (10) are well known and that vehicles comprising an internal combustion engine with augmentation by such an electric powered drive system are also well known and are commonly referred to as “hybrids.”

We may also readily appreciate that the beneficial effects of hybridization, economic and ecological, real and theoretical, and realized and potential, are well known. And further, we may readily appreciate that the basic principles of operation, modes of operation, and methods of operation, of all the components of hybridized vehicles, both individually and as they are interfaced and integrated into a functional unit, are well known. Therefore, these aspects of the instant art are not, herein, recounted in rigorous detail.

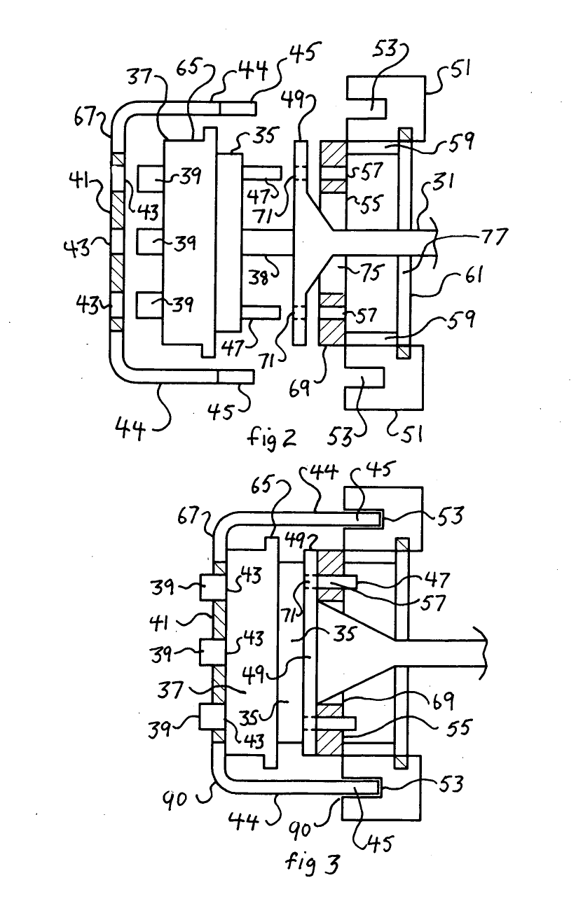

Looking now at FIG. 2, we see a substantially annular wheel support hub (65) comprising a rotating portion (37) rotatably communicating with a non-rotating, rigid portion (35). Also, we see that the rotating portion (37) comprises lug bolts (39) extending substantially perpendicularly from said rotating portion (37) and that the rigid portion (35) comprises hub bolts (47) extending substantially perpendicularly therefrom.

Attending again to FIG. 2, we note a non-movable axle support (31) which those skilled in the automotive art will readily appreciate is attached to the body or frame of a vehicle. Also, extending through said axle support (31), we note an axle (38) which extends through the rigid hub portion (35) to communicate with the rotating hub portion (37) in order to rotate said rotating hub portion (37) of the wheel support hub (65). In addition, we note as well that the non-movable axle support (31) comprises a non-movable hub plate (49) having hub plate holes (71).

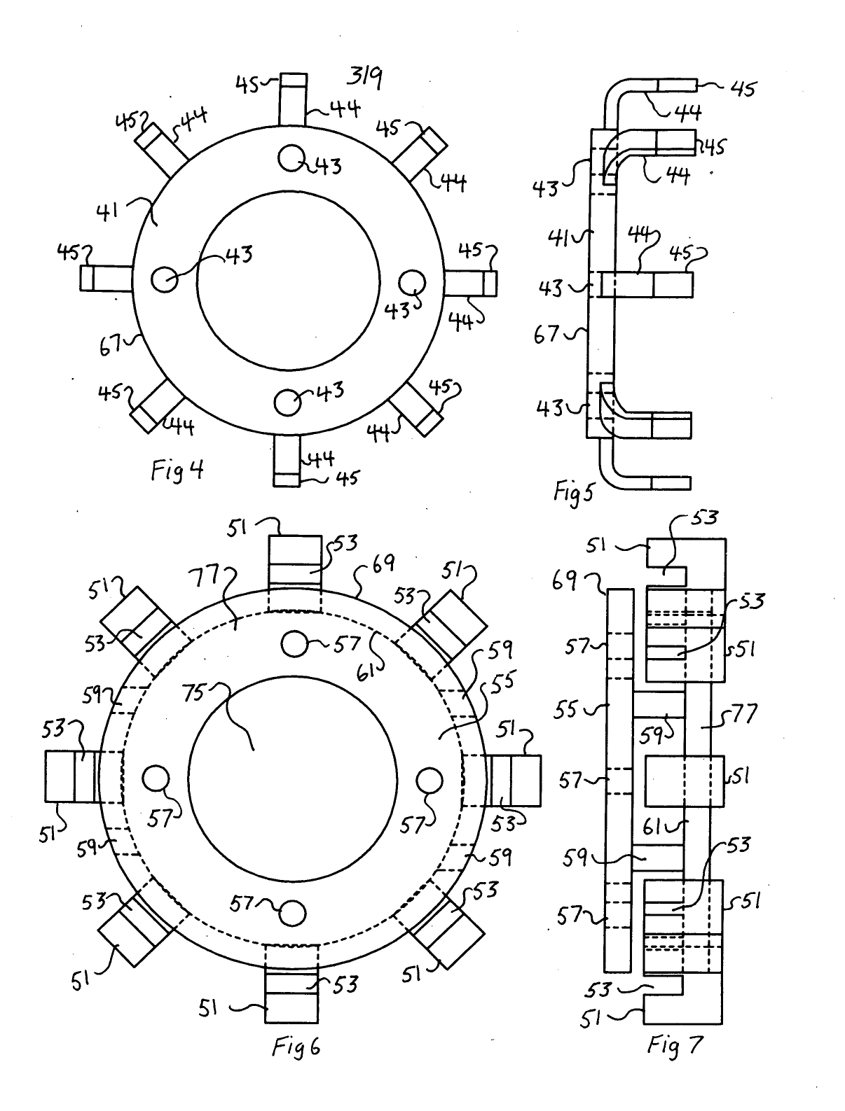

Turning yet again to FIG. 2, and to FIG. 4 and FIG. 5, we see a rotor (67) comprising a plate (41) having holes (43) and a plurality of rotor arms (44) extending at a substantially perpendicular angle to the plane of the rotor plate (41) with permanent magnets (45) disposed at the extremities of the rotor arms (44) opposite the rotor plate (41). Also, we see that said permanent magnets (45) are disposed in an essentially annular array.

Attending now to FIG. 2, FIG. 6, and FIG. 7, we see a stator (69) comprising a stator plate (55) having holes (57), a central void (75) through which the non-movable axle support (31) and/or axle (33) may pass, and stator arms (59) extending substantially perpendicularly from the periphery of the stator plate (55). In addition, we note that the stator arms support a stator ring (61) essentially parallel to the stator plate (55), said stator ring (61) comprising an aperture (77) through which the non-movable axle support (31) and/or axle (33) may pass. Supported by the stator ring (61) are electromagnets (51) having slots (53), said slots (53) oriented substantially perpendicularly to the stator plate (55). Also, we note that said slots (53) are disposed in a substantially annular array.

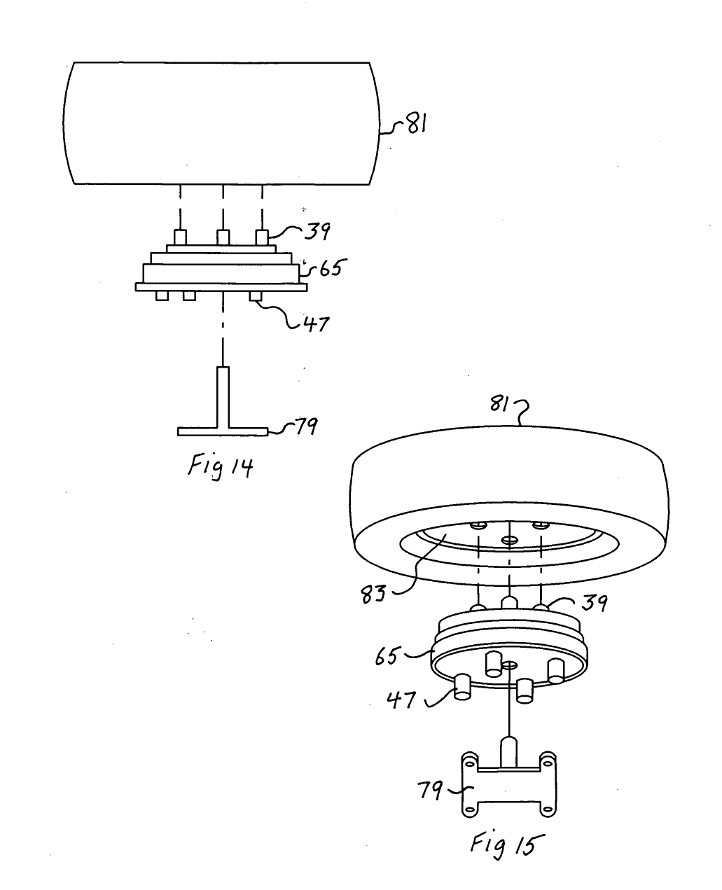

Looking now at FIGS. 3, 9, 10, 11, 12, 13, 14, and 15 we see that the hub bolts (47) align with the hub plate holes (71) and the stator plate holes (57) and may be extended therethrough so that a portion of said hub bolts (47) may extend beyond the stator plate (55). Now we may readily appreciate that a nut (not shown) may be engaged by the hub bolts (47) to fix the stator (69), the non-movable hub plate (49), and the rigid hub portion (35) of the wheel support hub (65) in a functional disposition.

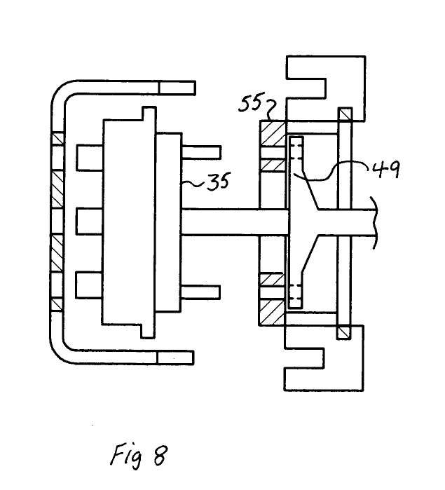

Looking now at FIG. 8, we see that the stator plate (55) may be configured so that said stator plate (55) is disposed between the rigid hub portion (35) and the non-movable hub plate (49).

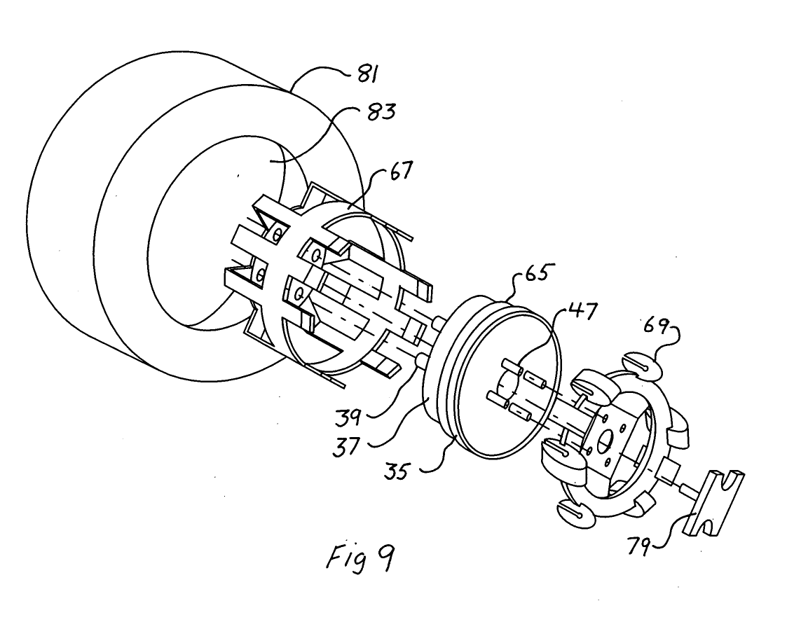

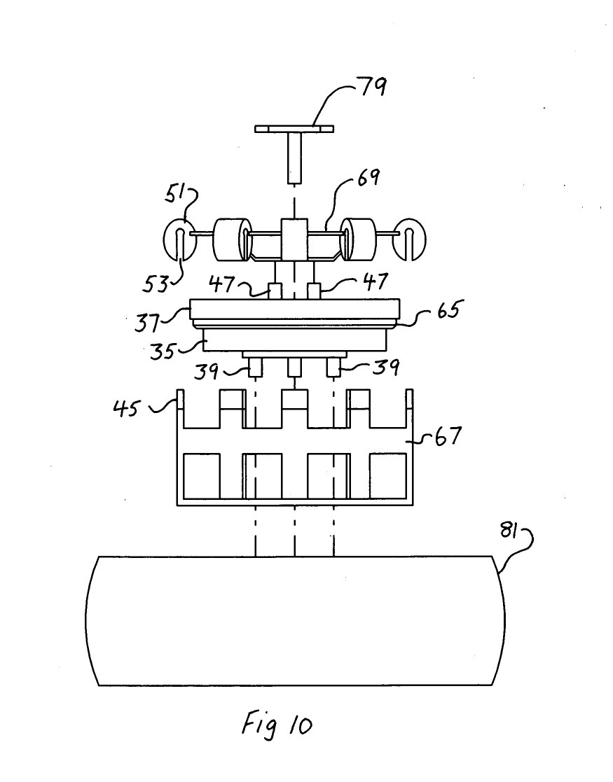

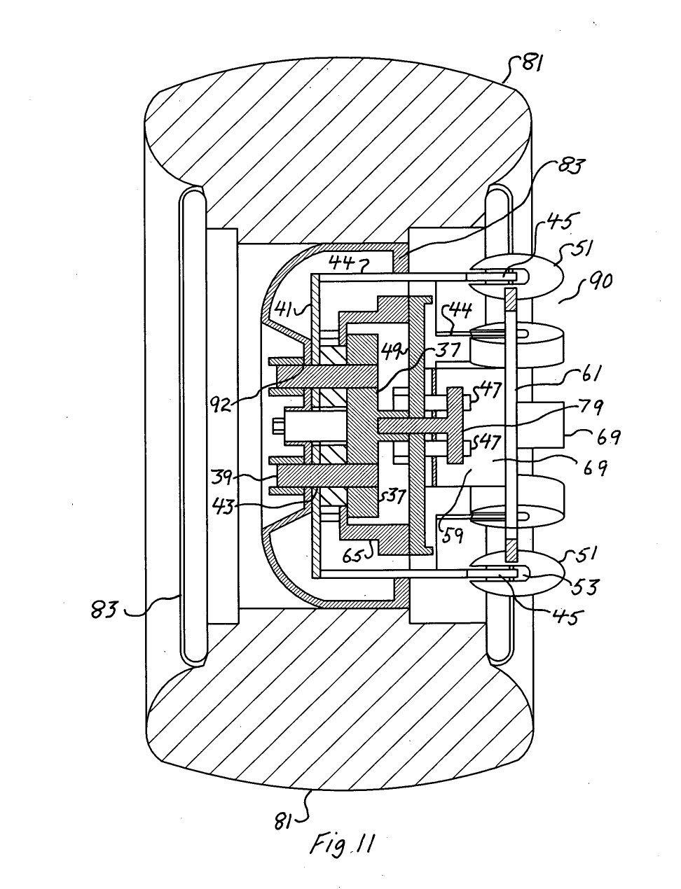

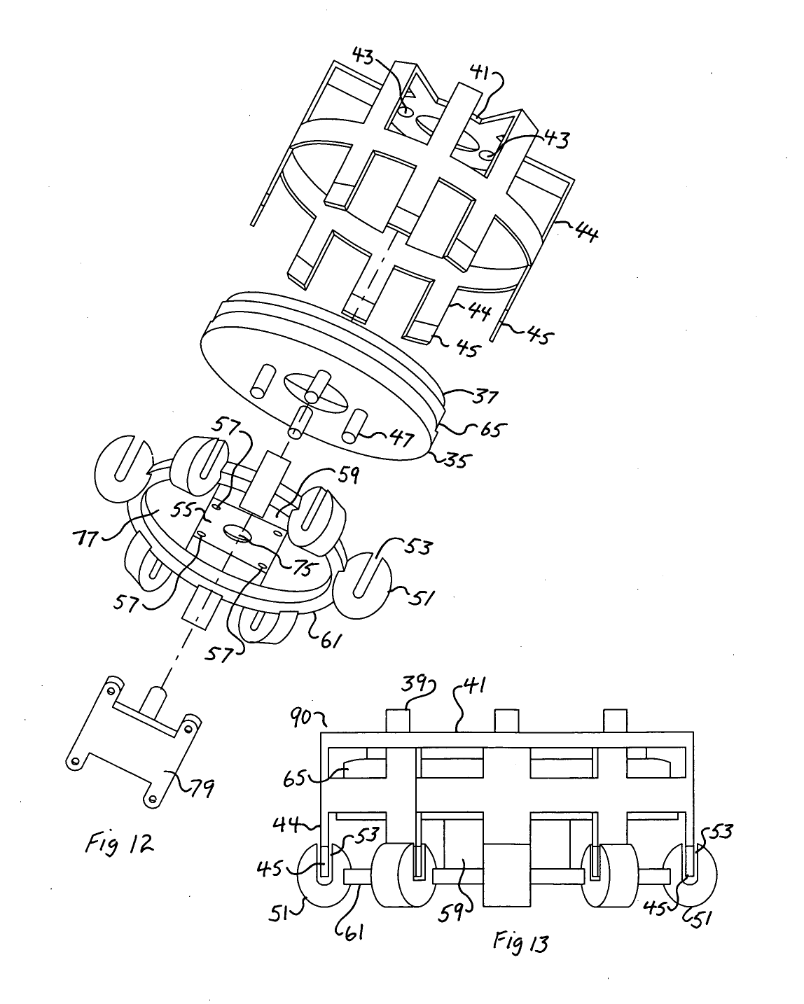

Looking further at FIGS. 3, 9, 10, 11, 12, 13, 14, and 15, we note that the rotor plate holes (43) align with the lug bolts (39) so that the lug bolts (39) may extend therethrough whereupon said lug bolts extend beyond the rotor plate (41). Thus, we may readily appreciate that said extension would allow a wheel rim and hub (83) mounting a tire (81), and having holes (92) corresponding to said lug bolts (39) to be mounted on the wheel support hub (65) with the rotor (67) held therebetween, the whole held fixed by nuts (not shown) engaging the lug bolts (39). In addition, we note in FIGS. 9, 10, 11, 12, 13, 14, and 15, that the means to facilitate the transfer of rotary motion to the wheel support hub (65) may comprise a backing plate (79)

Looking yet again at FIG. 3, we note that diameter of the rotor plate (41) is greater than both the diameter of the wheel support hub (65), the diameter of the non-movable hub plate (49), and the diameter of the stator plate (55) so that when the rotor (67), wheel support hub (65), non-movable axle support (31), and stator (69) communicate as previously described, the rotor arms (44) will extend such that the rotor permanent magnets (45) disposed at the extremities of the rotor arms (44) opposite the rotor plate (41) will be oriented in the electromagnet slots (53).

Thus, we may understand that when the rotating hub portion (37) rotates, the rotor (67) will also rotate while the rigid hub portion (35), the non-movable hub plate (49), and the stator (69) will not rotate. Therefore, we may also realize that when the rotor (67) rotates, the permanent magnets (45) will successively pass through each non-moving electromagnet slot (53).

In additionally sophisticated modes, the rotor (67) may comprise permanent magnet(s) of alternating polarity, and the stator (69) may comprise electromagnet(s) having phased and/or variable polarity. Further, the stator polarity may be controlled by a sensor and logic device responsive to position, power, velocity, and/or other factors. One product of such control can be an electromagnetic pull-in, then, push-out functional relationship between the non-rotating electromagnetic stator (69) and the permanent magnet rotating rotor (67). As a rotor arm (44) approaches a stator arm (59), the electromagnetic polarity of the stator arm (59) it approaches pulls the rotor arm (44) toward itself, while the electromagnetic polarity of the stator arm (59) the rotor arm (44) is just passing, pushes it away.

Now, those skilled in the art will readily appreciate that the rotor (67) and stator (69), disposed as previously described, comprising an electric motor (90) already extant may be incorporated into sundry vehicle system designs already extant. We may additionally understand that construction of said electric motor (90) is accomplished by the integration of the rotor (67) and stator (69) with elements common to the preponderant portion of extant motor vehicles essentially without modification of or sophistication of any said elements.

Thus, by exploitation of the instant art, an electric motor for motive power may be added to most present vehicles and vehicle design without significant modification of or sophistication of any parts of these vehicles. And, by exploitation of the instant art, an electric motor for motive power may be added to most motor vehicles during the manufacture of said vehicles without the redesign or remanufacture of any elements comprising said vehicles.

Those skilled in the art will additionally recognize that the electric motor (90) taught by the instant art, when employed to hybridize a vehicle, may, occasionally also serve as an electric power source, whereby drag from the generation of electrical energy may be exploited to provide vehicle deceleration and braking, the functional shift from motor to generator and back again being executed by a sensor/logic/switching system, sundry of which are well known in the art. Thus, electricity produced thereby may be used to recharge a battery, cell, or other energy storage device carried aboard the vehicle.

Also, activation/deactivation of the system may be automated by employing sensor and logic systems to detect and respond to optimum conditions for bringing appropriate components of the system on-line and for taking the system off-line. Sensors that might be employed for such purposes include an electric motor/generator rotor position sensor, automobile brake light switch, organic cruise control, accelerometers, and other like sensors. Although not shown in the drawings, such components and functions are, by this addressed and taught, herein. Incorporation of input from such sensor systems as are already organic to the associated vehicle can produce significant savings in overall system cost and expense.

Further, it is particularly notable that the herein taught electric motor may function, and produce considerable power, fitted with as little as only one stator arm and electromagnet (51). This is a significant advantage with regard to implementation on a wide variety of rear wheel configurations.

In addition, those skilled in the art will also readily appreciate that while the components used to accomplish functional communication between a rotating element and an axle of a vehicle may vary significantly in appearance from those shown, the principles utilized to do so are essentially the same in substantially all instances. Namely, a non-rotating element of the motor (69) is attached to a non-rotating portion of a hub assembly (35), and a rotating element of the motor (67) is supported by a non-rotating portion of a hub assembly wheel support hub (37). Thus, we may understand that the instant art may be contrived to be employed in virtually any vehicle without departing from the previous showing and description.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for addition of motive force to a vehicle as a part of an internal combustion engine-electric motor hybrid drive system for a vehicle comprising:
a rotor plate;
a rotor arm;
a rotor permanent magnet;
a stator plate;
a stator arm;
a stator ring or mount;
a stator electro magnets; and
a battery, cell, or other energy storage device.

2. A retro-fitable electric traction motor, hybrid conversion kit and device for automobiles, comprising:
one or more rotor plates;
one or more rotor arms;
one or more rotor permanent magnets;
one or more stator plates;
one or more one or more stator arms
one or more stator ring or mounts;
one or more stator electro magnets; and
one or more batteries, cells, or other energy storage devices.

3. A device as in claim 1 wherein one or more wheel assemblies are converted to electrical motors.

4. A device as in claim 1 or claim 2 wherein one or more wheel assemblies are converted to electrical energy generators.

5. A device as in claim 1 or claim 2 wherein the said wheel assemblies may use vehicle momentum to generate electrical energy

6. A device as in claim 4 wherein drag from the said process of generating electrical energy is or may be exploited to provide vehicle deceleration and braking.

7. A device as in claim 1 or claim 2 wherein the said rotor comprises two or more permanent magnets of alternating polarity.

8. A device as in claim 1 or claim 2 wherein the said stator comprises one or more electromagnets having variable or phased polarity.

9. A device as in claim 8 wherein the said one or more stator electromagnet(s) are essentially configured in the shape the letter C or the letter U so as to locate each of the two poles of any given stator magnate alongside its opposite pole.

10. A device as in claim 1 or claim 2 or claim 8, or claim 9 wherein the said permanent magnets of the said rotor are so configured as to pass between both poles of the said stator electromagnet(s).

11. A device as in claim 8 wherein is also comprised one or more rotor position sensors, the information from which is used to govern polarity of the said electromagnets.

12. A device as in claim 1 or claim 2 wherein is also comprised a means of sensing and concurrently or alternatively, measuring, rotor velocity.

13. A device as in claim l or claim 2 wherein is also comprised an means of automated activation of the said electrical motor, optimized as desired to meet energy, and, alternatively or concurrently, energy savings requirements.

14. An apparatus comprising a clamshell electric motor, consisting of a rotor plate and stator plate which together form a DC brushless motor, installed integrally with the existing rear wheel/spindle of a motor vehicle, wherein the stator plate is mounted between a brake assembly and backing plate of the said motor vehicle and wherein the rotor plate and stator plate are held in place by the same mounting bolts, nuts or other connective devices with which the vehicle was originally equipped.

15. An apparatus described in claim 9, in which the one or more C-magnets comprise non-ferromagnetic electromagnets.

16. An apparatus described in claim 9, in which the one or more C-magnets comprise ferromagnetic electromagnets.

17. An apparatus described in claim 1 or claim 2 in which the electric motor is activated by an electronic motor/engine control and attached to a battery pack

18. A method to convert front wheel drive automobile to plug-in hybrid by installation of the said clamshell electric motor of claim 14.

19. A retro-fitable electric traction motor, hybrid conversion kit and device for automobiles, comprising:
one or more rotor plates;
one or more rotor arms;
one or more rotor permanent magnets;
one or more stator plates;
one or more one or more stator arms
one or more stator ring or mounts;
one or more stator electro magnets; and
one or more batteries, cells, or other energy storage devices,
wherein one or more wheel assemblies are converted to electrical motors,
wherein one or more wheel assemblies are, or are so configured that they may be, converted to electrical energy generators,
wherein the said wheel assemblies may draw upon vehicle momentum to generate electrical energy,
wherein drag resulting from the said generation of electrical energy is exploited to provide vehicle deceleration and braking,
wherein the said rotor comprises two or more permanent magnets of alternating polarity,
wherein the said stator comprises one or more electromagnets having variable or phased polarity,
wherein the said one or more stator electromagnet(s) are essentially configured in the shape the letter C or the letter U so as to locate each of the two poles of any given stator magnate alongside its opposite pole,
wherein the said permanent magnets of the said rotor are so configured as to pass between both poles of the said one or more stator electromagnet(s),
wherein is also comprised one or more rotor position sensors, the information from which is used to govern polarity of the said electromagnets,
wherein is also comprised a means of sensing, and, concurrently or alternatively, measuring, rotor velocity,
wherein is also comprised an means of automated activation of the said electrical motor, optimized as desired to meet energy, and, alternatively or concurrently, energy savings requirements,
wherein the said device comprises a clamshell electric motor, having of a rotor plate and stator plate which together form a DC brushless motor, installed integrally with the existing wheel or spindle of a motor vehicle, wherein the stator plate is mounted between a brake assembly and backing plate of the said motor vehicle and wherein the rotor plate and stator plate are held in place by the same mounting bolts, nuts or other connective devices with which the vehicle was originally equipped,
wherein the C-magnets comprise non-ferromagnetic electromagnets,
and, wherein the electric motor is activated by an electronic motor/engine control and attached to a battery pack.
